(19) United States
(12) Patent Application Publication
(10) Pub. No.: US 2024/0344775 A1
(43) Pub. Date: Oct. 17, 2024

(54) Method for Controlling the Thermal Reservoir Utilization Balance of a Pumped Thermal Energy Storage System

(71) Applicant: SUPERCRITICAL STORAGE COMPANY, Lewes, DE (US)

(72) Inventors: Timothy J. Held, Akron, OH (US); Shawn Engle, Maple Valley, WA (US)

(21) Appl. No.: 18/405,352

(22) Filed: Jan. 5, 2024

Related U.S. Application Data
(60) Provisional application No. 63/492,608, filed on Mar. 28, 2023.

(51) Int. Cl. F28D 20/00

(52) U.S. Cl. CPC F28D 20/0034; F28D 2020/0069; F28D 2020/0082

(57) ABSTRACT

A pumped thermal energy storage system includes an auxiliary cooling system, a working fluid circuit, a sensor system, and a flow control process. The working fluid circuit further includes a recuperator and a thermal reservoir. The recuperator has a low-pressure side and a high-pressure side and is connected in parallel with the auxiliary cooling system on the low-pressure side. The sensor system senses operational parameters of the working fluid at predetermined points in the working fluid circuit, the sensed operational parameters include temperature and pressure. The flow control process controls the flow of a working fluid through the working fluid circuit responsive to the sensed operational parameters to balance the heat transferred into the working fluid with the heat transferred out of the working fluid.

### CROSS-REFERENCE TO RELATED APPLICATION

This paper claims priority to, and the earlier effective filing date of, U.S. Application Ser. No. 63/492,608, filed Mar. 28, 2023, for all purposes, including the purpose of priority. U.S. Application Ser. No. 63/492,608 is hereby incorporated by reference as if expressly set forth verbatim herein.

### STATEMENT REGARDING FEDERALLY SPONSORED RESEARCH OR DEVELOPMENT

This invention was made with government support under DE-AR0000996 awarded by the U.S. Department of Energy. The government has certain rights in the invention.

### BACKGROUND

A pumped thermal energy storage system (“PTES”) consists of an electrically-driven heat pump system that transfers heat from a low-temperature thermal reservoir (“LTR”) to a higher temperature thermal reservoir (“HTR”) in a “charging” process. At a later time, the heat stored in the HTR can be used in a “generating” process to drive a heat engine (essentially the heat pump operating in reverse), thereby returning the thermal energy back to the LTR. In a thermodynamically ideal system, the amount of heat transferred from the LTR to the HTR during charging would be equal to the heat transferred from the HTR to the LTR during generating. This will be referred to as a thermal system that is “balanced”. However, thermodynamic irreversibilities result in an imbalance in the thermal reservoirs over time, and thus action should be taken to maintain the balanced state.

Due to the second law of thermodynamics, non-ideal processes result in excess heat being generated. The problem of PTES thermal balancing therefore includes disposing of excess heat at a minimum penalty to the system performance, generally evaluated by the round-trip efficiency (“RTE”) of the charging/generating system. In the particular case of interest here, the heat pump/heat engine working fluid is carbon dioxide (CO₂). The properties of CO₂ are such that the specific heat capacity of the fluid over the pressure and temperature range of interest for PTES applications is a strong function of pressure, unlike an ideal gas.

As a result, further modifications to the simplified PTES system discussed above are desired to limit the irreversibility associated with heat capacity imbalance in the recuperator heat exchanger. In a previous approach, a third “medium-temperature” reservoir (“MTR”) is added to the system design. This reservoir is connected in parallel to the high-pressure side of the recuperator. This equipment arrangement allows for improved heat capacity matching across the recuperator, reducing the exergy destruction in the recuperator and improving the performance of the PTES system. However, the added reservoir increases the complexity of the system thermal balancing. Now, rather than balancing only the heat transferred to/from the HTR (Q_{HTR}) and LTR (Q_{LTR}), a third reservoir is also thermally balanced (Q_{MTR}).

### SUMMARY

In a first aspect, a pumped thermal energy storage system comprises, in a generating phase, an auxiliary cooling system, a working fluid circuit, a sensor system, and a flow control process. The working fluid circuit includes a working fluid circulating through the working fluid circuit, a recuperator and a plurality of thermal reservoirs. The plurality of thermal reservoirs includes at least a first thermal reservoir and a second thermal reservoir. The sensor system senses operational parameters of the working fluid at a first set of predetermined points in the working fluid circuit and at least a portion of the plurality of thermal reservoirs. The flow control process controls the flow of the working fluid through the working fluid circuit and, responsive to the sensed operational parameters, balances the heat transferred from the first thermal reservoir with the heat transferred to the second thermal reservoir.

In a second aspect, a pumped thermal energy storage system comprises, in a generating phase, an auxiliary cooling system, a working fluid circuit, a sensor system, and a flow control process. The working fluid circuit includes a working fluid circulating through the working fluid circuit, a plurality of flow control valves, an expansion device, a compression device, a plurality of thermal reservoirs, and a recuperator. The thermal reservoirs include a low temperature reservoir, a medium temperature reservoir, and a high temperature reservoir. The recuperator has a high-pressure side and a low-pressure side. The recuperator is fluidly coupled to the compression device on the high-pressure side and fluidly coupled to the expansion device on the low-pressure side and is positioned in parallel to the auxiliary cooling system on the low-pressure side. The PTES system also includes a sensor system and a flow control process. The sensor system senses operational parameters of the working fluid at a first set of predetermined points in the working fluid circuit. The flow control process controls the flow of the working fluid through the working fluid circuit and, responsive to the sensed operational parameters, controls the flow of the working fluid to achieve a desired target ratio of Q_{HTR}/Q_{LTR} and Q_{MTR}/Q_{LTR} simultaneously and dynamically during system operation.

In a third aspect, a method for operating a pumped thermal energy storage system, comprises: cycling the pumped thermal energy storage system through a generating phase and a charging phase; circulating a working fluid through a working fluid circuit; sensing operational parameters of the working fluid at a first set of predetermined points in the working fluid circuit as the working fluid circulates; and in the generating phase, controlling the flow of a working fluid through the working fluid circuit responsive to the sensed operational parameters to balance the heat transferred from a first thermal reservoir with the heat transferred to a second thermal reservoir.

In a fourth aspect, a computer-implemented method for controlling a pumped thermal energy storage system, comprising: receiving a plurality of sensor signals from a plurality of sensors sensing operational parameters of a working fluid at a first set of predetermined points in a working fluid circuit while the working fluid is circulating through a working fluid circuit in a generating phase; and in the generating phase, responsive to the received sensor signals, sending a plurality of control signals to a plurality of flow control valves positioned at a second set of predetermined points in the working fluid circuit to balance the heat transferred from a first thermal reservoir with the heat transferred to a second thermal reservoir.

In a fifth aspect, an apparatus comprises a flow process control that, in use, operates in a pumped thermal energy storage (“PTES”) system cycling through a generating phase and a charging phase. The flow process control includes an electronic controller. The electronic controller further includes a processor-based resource and a memory. The memory is encoded with executable instructions that, when executed by the processor-based resource, perform a method. The method comprises receiving a plurality of sensor signals from a plurality of sensors sensing operational parameters of a working fluid of the PTES system at a first set of predetermined points in a working fluid circuit while the working fluid is circulating through a working fluid circuit in a generating phase; and, in the generating phase, responsive to the received sensor signals, sending a plurality of control signals to a plurality of flow control valves positioned at a second set of predetermined points in the working fluid circuit to balance the heat transferred from a first thermal reservoir with the heat transferred to a second thermal reservoir.

The above presents a simplified summary in order to provide a basic understanding of some aspects of the invention. This summary is not an exhaustive overview of the invention. It is not intended to identify key or critical elements of the disclosure or to delineate the scope of the invention. Its sole purpose is to present some concepts in a simplified form as a prelude to the more detailed description that is discussed later.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1 is a pumped thermal energy storage system in the generating phase of the operational cycle thereof according to one or more examples of the disclosure.

FIG. 2 depicts one particular embodiment of a flow control process as may be used in the pumped thermal energy storage system of FIG. 1.

FIG. 3 shows the results of a simulation of the pumped thermal energy storage system of FIG. 1 illustrating the efficacy of the technique disclosed herein.

FIG. 4 is a process flow diagram for a PTES system during a charging phase of a PTES operational cycle whose generating phase is shown in FIG. 1 in accordance with one or more embodiments.

While the disclosed technique is susceptible to various modifications and alternative forms, the drawings illustrate specific embodiments herein described in detail by way of example. It should be understood, however, that the description herein of specific embodiments is not intended to limit that which is claimed to the particular forms disclosed, but on the contrary, the intention is to cover all modifications, equivalents, and alternatives falling within the spirit and scope of the appended claims.

### DETAILED DESCRIPTION

Illustrative embodiments of the subject matter claimed below will now be disclosed. In the interest of clarity, not all features of an actual implementation are described in this specification. It will be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

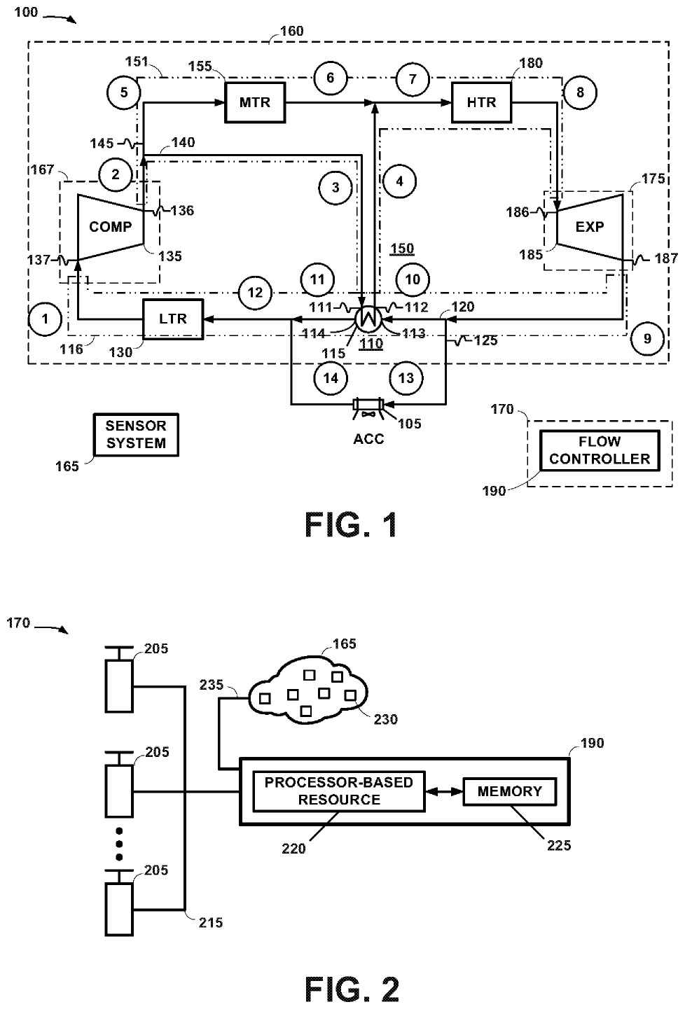

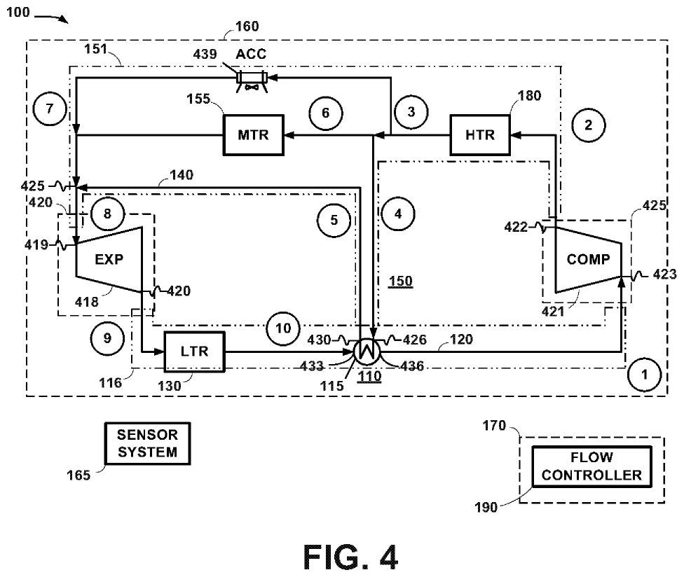

The present disclosure provides a technique for controlling the flow rates to several different flow paths within a pumped thermal energy storage system to achieve a desired target ratio of Q_{HTR}/Q_{LTR} and Q_{MTR}/Q_{LTR} simultaneously and dynamically during system operation over a wide range of operating conditions. Referring to FIG. 1, the disclosed technique includes a pumped thermal energy storage (“PTES”) system 100 in which the optional auxiliary cooling system 105 (“ACC”), is connected in parallel to the low-pressure side 110 of the recuperator 115 (“RCX”). FIG. 1 is, more particularly, the PTES system 100 in the generating phase of the operational cycle thereof. The charging phase of the operational cycle will be briefly discussed in connection with FIG. 4 below.

The working fluid flow at State 9 (identified by a numeral in a circle) is divided into two separate portions. The first portion 120 passes through the low-pressure side 110 of the recuperator 115 (State 10 to State 11), while the second portion 125 passes through the ACC (State 13 to Stage 14). Both portions are cooled in the process, and recombine at State 12, prior to entering the low temperature reservoir 130 (“LTR”).

Separately, and simultaneously, the working fluid flow exiting the compression device (“COMP”) 135 (State 2) is divided into a third portion 140 and a fourth portion 145. The third portion 140 passes through the high-pressure side 150 of the recuperator 115, while the fourth portion 145 passes through the medium temperature reservoir (“MTR”) 155. Both the third portion 140 and the fourth portion 145 are heated in their respective devices, recuperator 115 (State 3 to State 4) and MTR 155 (State 5 to State 6), respectively. The third portion 140 and the fourth portion 145 and then are combined together to form State 7.

More fully, and still referring to FIG. 1, the pumped thermal energy storage system 100 comprises, in this particular embodiment, the auxiliary cooling system 105, a working fluid circuit 160, a sensor system 165, and a flow control process 170. A working fluid (not shown) circulates through the working fluid circuit 160 and heat is exchanged from and to the working fluid in a manner as discussed more particularly below. The working fluid may be, for example, Carbon dioxide (CO₂), although the working fluid may be implemented using other fluids in other embodiments. In the illustrated embodiment, the working fluid is CO₂. Alternative embodiments may use alternative working fluids as are known to the art.

The working fluid circuit 160 includes not only the recuperator 115, but also a compression process 167, an expansion process 175, and a plurality of thermal reservoirs. The plurality of thermal reservoirs includes not only the aforementioned LTR 130 and MTR 155, but also a high temperature reservoir (“HTR”) 180. The PTES system 100 may be characterized as a “three reservoir system” because there are three reservoirs—the HTR 180, the LTR 130, and the MTR 155.

The HTR 180 is so called because it operates at temperatures higher than those at which the LTR 130 and the MTR 155 operate. Similarly, the LTR 130 operates at temperatures lower than those at which the HTR 180 and the MTR 155 operate. The MTR 155 operates at temperatures intermediate those at which the HTR 180 and the LTR 130 operate. Thus, relative to the reservoirs HTR 180, LTR 130, and MTR 155, the terms “high”, “medium”, and “low” describe the relative temperatures at which the three reservoirs HTR 180, LTR 130, and MTR 155 operate.

Each of the thermal reservoirs HTR 180, LTR 130, and MTR 155 include a thermal storage medium not separately shown. In the illustrated embodiment, the thermal storage media are sand, liquid water and a water/ice mixture for the HTR 180, MTR 155, and LTR 130, respectively. However, the thermal storage medium may be any suitable thermal storage medium and alternative embodiments may use alternative thermal storage media. Each of the thermal reservoirs HTR 180, MTR 155, and LTR 130 may include heat exchangers, piping, pumps, valves, and other controls not separately shown to transfer heat between the thermal storage media and the working fluid during operation of the PTES system 100.

Still referring to FIG. 1, the compression process 167 comprises, in this particular embodiment, the compression device 135. The compression device 135 may be implemented in any suitable compression device known to the art. The compression device 135 may be a pump, for example, such as a circuit and centrifugal pump, a piston pump, or some other kind of positive displacement pump. The compression device may alternatively be a compressor, for example, such as a fully hermetic reciprocating compressor or a scroll compressor. Those skilled in the art having the benefit of this disclosure may appreciate still other implementations. Note that some embodiments may employ more than one compression device. In embodiments employing multiple compression devices, the plurality may be implemented using different kinds of compression devices.

The expansion process 175 comprises an expansion device 185. The expansion device 185 may be implemented using any suitable expansion device known to the art. The expansion device may be, for example, a turbine or a positive displacement expander. Those skilled in the art having the benefit of this disclosure may appreciate still other implementations. Note that some embodiments may employ more than one expansion device. In embodiments employing multiple expansion devices, the plurality may be implemented using different kinds of expansion devices.

The compression process 167 compresses the working fluid to increase its pressure and provide the motive force for circulating the working fluid through the working fluid circuit 160. The expansion process 175 expands the working fluid which depressurizes, or decreases the pressure of, the working fluid and converts the fluid pressure to mechanical work. This creates a generally higher pressure in portions of the working fluid circuit 160 than in other portions of the working fluid circuit. Accordingly, the terms “high-pressure” and “low-pressure” in the phrases “high-pressure side” and “low-pressure side” are construed relative to one another rather than in absolute quantifications.

The disclosure herein therefore references the “high-pressure side” and the “low-pressure side” of the recuperator 115. The portion of the working fluid circuit 160 through which the working fluid is pressurized by the compression process 167 circulates may be referred to as the “high-pressure side” of the working fluid circuit 160. Similarly, the portion of the working fluid circuit 160 through which the working fluid expanded by the expansion process 175 circulates may be referred to as the “low-pressure side” of the recuperator 115 and the working fluid circuit 160. Thus, the high-pressure side 151 of the working fluid circuit 160 extends from the outlet 136 of the compression device 135 to the inlet 186 of the expansion device 185. The low-pressure side 116 of the working fluid circuit extends from the outlet 187 of the expansion device 185 to the inlet 137 of the compression device 135.

The high-pressure side 150 of the recuperator 115 is the side of the recuperator 115 that interfaces with the high-pressure side 151 of the working fluid circuit 160. In the charging phase shown in FIG. 4, that would be the side of the recuperator 115 defined by the ports 111, 112 by which the pressurized working fluid circulates through the recuperator 115. The low-pressure side 110 of the recuperator 115 is the side that interfaces with the low-pressure side 116 of the working fluid circuit 160. The low-pressure side of the recuperator 115 is defined by the ports 113, 114 by which the expanded working fluid circulates through the recuperator 115. The low-pressure side 110 of the recuperator 115 is operatively connected to the low-pressure side of the working fluid circuit 160. The high-pressure side 150 of the recuperator 115 is operatively connected to the high-pressure side of the working fluid circuit 160.

As described above, the presently disclosed technique controls the flow of the working fluid through the working fluid circuit 160 to balance the heat transferred into and out of the working fluid. This flow control is implemented, in this particular embodiment, through the operation of the sensor system 165 and the flow controller 190 of the flow control process 170. More particularly, The flow control process 170 controls the flow of the working fluid through the working fluid circuit 160 responsive to the sensed operational parameters to achieve a desired target ratio of Q_{HTR}/Q_{LTR} and Q_{MTR}/Q_{LTR} simultaneously and dynamically during system operation.

The sensor system 165 comprises a plurality of sensors (not separately shown) that are implemented to sense operational parameters (e.g., take readings) of the working fluid at a first set of predetermined points in the working fluid circuit 160. The sensed operational parameters may include temperature and/or pressure. The sensed operational parameters may also include measurements of the state of charge of one or more of the thermal reservoirs, where the state of charge ranges from 0% at the fully-discharged state and 100% at the fully charged state. Many embodiments will also sense flow rates at one or more of the predetermined points of the working fluid circuit 160. This type of sensing is already commonly utilized in PTES systems and routine sensing techniques may be employed. Accordingly, the sensed operational parameters in various embodiments may include temperature, or pressure, or a charge state for the plurality of thermal reservoirs, or some combination thereof.

Not separately shown in FIG. 1 are the flow control devices that permit the division of the flow into the various portions. Representative elements of the flow control process 170 are shown in FIG. 2. In this particular embodiment, the flow control process 170 includes a plurality of fluid flow valves 205 and an electronic controller 210 sending control signals over electrical lines 215. The flow control process 170 may also include control over operational characteristics of, for example, the compression device 135 and/or the expansion device 185 such as, but not limited to, shaft speed and variable geometry features. The flow control process 170 also consumes data provided by the individual sensors 230 of the sensor system 165 provided over the electrical lines 235.

The electronic controller 210 includes a processor-based resource 220 that may be, for example and without limitation, a microcontroller, a microprocessor, an Application Specific Integrated Circuit (“ASIC”), an Electrically Erasable Programmable Read-Only Memory (“EEPROM”), or the like. Depending on the implementation of the processor-based resource, the electronic controller 210 may also include a memory 225 encoded with instructions (not shown) executable by the processor-based resource 220 to implement the functionality of the electronic controller 210. Again, depending on the implementation of the processor-based resource 220, the memory 225 may be a part of the processor-based resource 220 or a stand-alone device. For example, the instructions may be firmware stored in the memory portion of a microprocessor or they may be a routine stored in a stand-alone read-only or random-access memory chip. Similarly, in some implementations of the processor-based resource 220—e.g., an ASIC—the memory 235 may be omitted altogether.

The fluid flow control valves 205 may be variable-orifice (or flow control) valves. The fluid flow control valves 205 may be positioned at a second set of predetermined points in the working fluid circuit 160. This second set of predetermined points may be at points in the working fluid circuit 160 where the working fluid is in State 10 for the recuperator 115 and State 13 for the auxiliary cooling system 105, respectively. The second set of predetermined points may also include points in the working fluid circuit 160 where the working fluid is in State 2 and State 5 for the recuperator 115 and MTR 155, respectively. Alternatively, a limited number of fluid flow control valves 205 may be used (for instance, at States 5 and 13) to modulate the working fluid flow rate, while the flow rate through States 2 and 10 will be controlled by the natural pressure drop of the recuperator 115. Alternatively, diverter valves that can continuously direct variable portions of the flows to the various devices could be used in some embodiments.

The flow control process 170 will monitor the amount of heat that is being transferred to and from the three reservoirs via temperature and pressure measurements at the inlet and outlet states of the working fluid circuit, and/or measurements of the states of charge of the thermal reservoirs, for instance by the quantity and temperature of the heated or cooled materials that comprise the storage media in the thermal reservoirs. The flow control process 170 will adjust the flow distribution between States 2 and 5, and between States 10 and 13, in order to achieve a targeted thermal reservoir heat distribution.

More particularly, in some embodiments, the sensor system 165 senses the state of charge of the thermal reservoirs that the flow control process 170 then uses to control the ratios as described above. Such ratios may include, for example and without limitation, ratio of Q_{HTR}/Q_{LTR} and Q_{MTR}/Q_{LTR}. In some of these embodiments, the state of charge for the thermal reservoirs may be defined by the quantity and temperature of the heated or cooled materials that comprise the storage media in the thermal reservoirs. The sensor system 165 may also be able to determine the state of charge of any or all of the thermal reservoirs in order to accommodate imbalances that arise from things like self-discharge while the system is charged but idle.

Thus, a pumped thermal energy storage system comprises an auxiliary cooling system, a working fluid circuit, a sensor system, and a flow control process. The working fluid circuit includes a recuperator and a thermal reservoir. The recuperator has a low-pressure side and a high-pressure side and is connected in parallel with the auxiliary cooling system on the low-pressure side. The sensor system senses operational parameters of the working fluid at predetermined points in the working fluid circuit, the sensed operational parameters including temperature, pressure, and (optionally) that states of charge for the thermal reservoirs. The flow control process controls the flow of a working fluid through the working fluid circuit responsive to the sensed operational parameters to balance the heat transferred into the working fluid with the heat transferred out of the working fluid. The controlled balancing includes dividing the working fluid on the low-pressure side into a first portion and a second portion, the first portion passing through the recuperator and the second portion passing through the auxiliary cooling system and dividing the working fluid on the high-pressure side into a third portion and a fourth portion, the third portion passing through the recuperator and the fourth portion passing through the thermal reservoir.

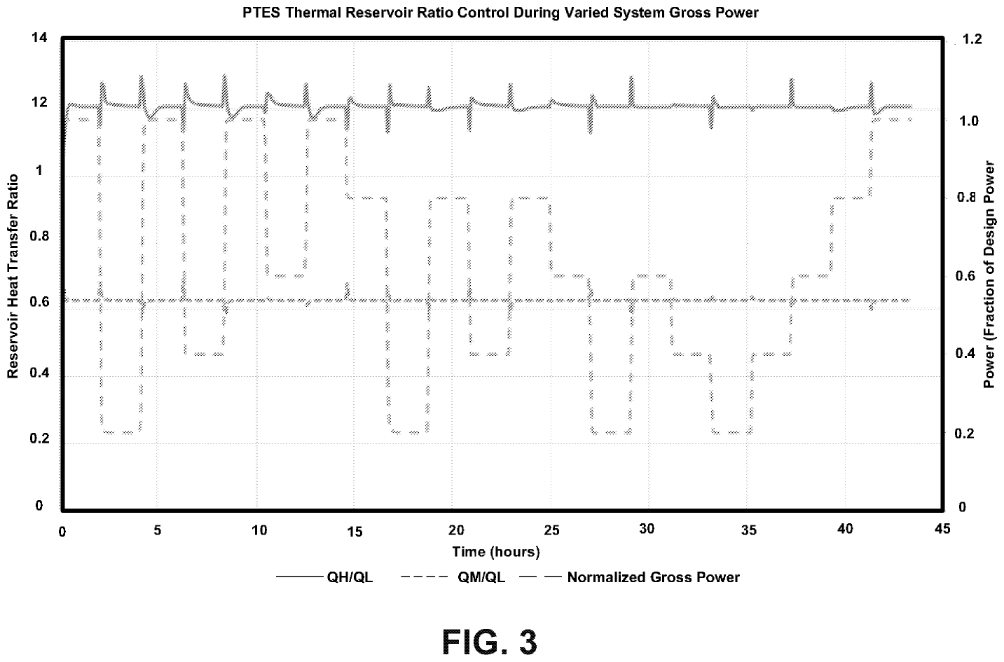

Steady-state and transient simulations of technique have demonstrated that this control strategy can maintain a targeted thermal distribution between the high temperature reservoir, medium temperature reservoir, and low temperature reservoir. The results of one such simulation that shows the reservoir thermal balance as the generating phase output is varied over a range 20-100% maximum power is shown in FIG. 3. The control system is able to achieve stable reservoir thermal balance with limited over/undershoot over a wide range of rapid transient conditions.

For the sake of completeness, an illustrative embodiment of a charging phase for the PTES system 100 of FIG. 1 is shown in FIG. 4 and will now be briefly discussed. In the charging phase, the working fluid circuit 160 includes an expander 418 in an expansion process 420 and a charge compressor 421 in a compression process 425. In the following discussion, the state of the working fluid at any given point in the working fluid circuit 160 during the charging phase in FIG. 4 is shown as a numeral in a circle. Thus, the first state, or State 1, is shown as the numeral 1 in a circle in FIG. 4.

The portion of the working fluid circuit 160 through which the working fluid is pressurized by the charge compressor 421 circulates may be referred to as the “high-pressure side” of the working fluid circuit 151. Similarly, the portion of the working fluid circuit 160 through which the working fluid expanded by the expander 418 circulates may be referred to as the “low-pressure side” of the working fluid circuit 160. Thus, the high-pressure side 151 of the working fluid circuit 160 extends from the outlet 422 of the charge compressor 421 to the inlet 419 of the expander 418. The low-pressure side 116 extends from the outlet 420 of the expander 418 to the inlet 423 of the charge compressor 421.

The high-pressure side of the recuperator 115 is the side of the recuperator 115 that interfaces with the high-pressure side 151 of the working fluid circuit 160. In the charging phase shown in FIG. 4, that would be the side of the recuperator 115 defined by the ports 426, 430 by which the pressurized working fluid circulates through the recuperator 115. The low-pressure side of the recuperator 115 is the side that interfaces with the low-pressure side 116 of the working fluid circuit 160. The low-pressure side of the recuperator 115 is defined by the ports 433, 436 by which the expanded working fluid circulates through the recuperator 115.

During the charging phase, beginning at the recuperator 115, the working fluid exits the recuperator 115 and enters charge compressor 421 in State 1. The charge compressor 421 compresses the working fluid and increases the temperature and pressure of the working fluid. The working fluid then leaves the charge compressor 421 in State 2. The working fluid then enters the high-temperature reservoir HTR 180 in State 2. In the HTR 180, heat is transferred from the working fluid to the thermal storage medium in the HTR 180. The heat transfer process reduces the pressure and the temperature of the working fluid to State 3 as the working fluid exits the HTR 180.

The working fluid then reaches a point 424 in the working fluid circuit 160 and splits. A first portion of the working fluid enters the bypass 415 and a second portion enters the line 427. The second portion enters the line 427 in State 4. The second portion then enters the high-pressure side 150 of the recuperator 115 through the port 426 in State 4. In the recuperator 115, heat is exchanged between the second portion and the circulating working fluid on the low-pressure side 110 of the recuperator 115. This heat exchange cools the second portion to State 5. The second portion then exits the recuperator 115 on the high-pressure side 150 of the recuperator 115 through the port 430 in State 6.

While the second portion is circulating through recuperator 115, the first portion enters the bypass 415 in a State 6. State 6 differs from State 3 by having a lower mass flow rate than does the third state although the second portion is at the same temperature and pressure as the working fluid in State 4. The first portion then enters the MTR 155 in State 6. In the MTR 155, heat is transferred between the medium-temperature thermal reservoir MTR 155 and the first portion of the working fluid. Recall that the MTR 155 operates at temperatures greater than the LTR 130 and less than the high-temperature thermal reservoir HTR 180. The first portion then exits the medium-temperature heat reservoir MTR 155 in State 7. Note the bypass around the MTR 155 and the recuperator 110 through the optional auxiliary cooling system (“ACC”) 439.

After the first portion exits the MTR 155 in State 7 and the second portion exits the recuperator 115 in State 5, the first and second portions combine at a point 425. After combining, the working fluid is in State 8. The combination of the first portion and the second portion, or the “combined portion”, then enters the expander 418 in State 8, whereupon it is expanded and cooled. The combined portion of the working fluid exits the expander 418 in State 9. The working fluid then enters the LTR 130 in State 9. In the LTR 130, heat is transferred from the LTR 130 to the working fluid. Note that the LTR 130 operates at temperatures lower than the medium temperature thermal reservoir MTR 155 and the high-temperature thermal reservoir HTR 180. The working fluid leaves the LTR 130 in State 10.

Upon exit from the LTR 130, the working fluid enters the recuperator 115 in State 10 and exits in State 1. In the recuperator 115, heat is transferred from the working fluid on the high-pressure side to the working fluid on the low-pressure side of the recuperator 115. The working fluid then begins again the circulation through the working fluid circuit 160 discussed immediately above.

Comparing the working circuit 160 in FIG. 1 and the working circuit 160 in FIG. 4 reveals two different configurations for the working circuit 160. Those in the art having the benefit of this disclosure will appreciate that the configuration of the working circuit 160 depends upon whether the PTES system 100 is in the generating phase of the operating cycle or in the charging phase. This configuring and reconfiguring may be managed by the flow control process 170 through the operation of the flow control valves 205 by the flow controller 190, both shown in FIG. 2, in some embodiments.

The PTES system embodiment disclosed herein is a three-reservoir embodiment in which the thermal reservoirs operate at “high”, “medium”, and “low” temperatures relative to one another as described above. However, other embodiments not shown may have other numbers of thermal reservoirs. For example, some embodiments may have only two thermal reservoirs, a high-temperature thermal reservoir and a low-temperature reservoir, and heat transfer from the high-temperature reservoir with heat transfer into the low-temperature reservoir. Other embodiments may have four or more thermal reservoirs. Those skilled in the art having the benefits of the disclosure herein will be able to readily extrapolate the teaching to other embodiments with differing numbers of thermal reservoirs.

Furthermore, the illustrated embodiment includes an auxiliary cooling system in each of the generating phase and the charging phase. In some embodiments, the auxiliary cooling system may be used to “dump” heat prior to storage and thereby reduce the size and cost of the medium temperature reservoir. However, there may be embodiments where it is desirable to omit the auxiliary cooling system while increasing the size of the medium thermal reservoir. Those in the art having the benefit of this disclosure may further realize other design considerations that may be affected by the inclusion or omission of the auxiliary cooling system in any given embodiment.

Note, however, that the technique disclosed herein is generally focused on balancing heat transferred from a thermal reservoir operating at a higher temperature to a thermal reservoir operating at a lower temperature. Thus, relative to the to the disclosed embodiment, the technique may balance Q_{HTR}/Q_{LTR}, or Q_{MTR}/Q_{LTR}. Note that to balance the one ratio is to balance the other in the illustrated embodiments. This may be a design concern for some embodiments in that the difference in temperatures between two reservoirs should be sufficient to have efficient and meaningful heat transfer.

Various aspects of this disclosure talk about “balancing” heat transfers between two thermal reservoirs. In a general sense, this may mean that the heat transferred from the first thermal reservoir is equal to the heat transferred into the second thermal reservoir. That is, one construction of the term “balancing” is that Q_{HTR}/Q_{LTR}=1, or Q_{MTR}/Q_{LTR}=1, or Q_{HTR}/Q_{LTR}=Q_{MTR}/Q_{LTR}=1. In these embodiments, the term “balancing” is measured against the two quantities of heat being transferred. However, this may not be the case in all embodiments and is not the default condition. The illustrated embodiments, for example, do not achieve a ratio of 1. Some embodiments, including the illustrated embodiments, may desire to achieve a heat transfer ratio that is ≠1, but rather greater than or less than 1. Thus, the term “balancing” as used herein means achieving one or more desired target ratios for heat transfer between two or more thermal reservoirs.

Accordingly, in a first embodiment, a pumped thermal energy storage system comprises: in a generating phase, a working fluid circuit, a sensor system, and a flow control process. The working fluid circuit includes a working fluid circulating through the working fluid circuit; a recuperator; and a plurality of thermal reservoirs. The plurality of thermal reservoirs includes at least a first thermal reservoir and a second thermal reservoir. The sensor system senses operational parameters of the working fluid at a first set of predetermined points in the working fluid circuit and at least a portion of the plurality of thermal reservoir. The flow control process controls the flow of the working fluid through the working fluid circuit and, responsive to the sensed operational parameters, balances the heat transferred from the first thermal reservoir with the heat transferred to the second thermal reservoir.

In a second embodiment, in the pumped thermal energy storage system of the first embodiment, the first thermal reservoir is a high temperature thermal reservoir and the second thermal reservoir is a low temperature reservoir.

In a third embodiment, in the pumped thermal energy storage system of the first embodiment, the first thermal reservoir is a medium temperature thermal reservoir and the second thermal reservoir is a low temperature reservoir.

In a fourth embodiment, in the pumped thermal energy storage system of the first embodiment, the plurality of thermal reservoirs of the working fluid circuit includes a third thermal reservoir and the flow control process controls the flow of the working fluid through the working fluid circuit responsive to the sensed operational parameters to balance the heat transferred from at least one of the first reservoir and the third reservoir to the second reservoir.

In a fifth embodiment, in the pumped thermal energy storage system of the fourth embodiment, the first thermal reservoir is a high temperature thermal reservoir, the second thermal reservoir is a low temperature reservoir, and the third thermal reservoir is a medium thermal reservoir.

In a sixth embodiment, in the pumped thermal energy storage system of the fourth embodiment, the flow control process controls the flow of the working fluid through the working fluid circuit responsive to the sensed operational parameters to balance the heat transferred from both of the first reservoir and the third reservoir to the second reservoir.

In a seventh embodiment, in the pumped thermal energy storage system of the sixth embodiment, the first thermal reservoir is a high temperature thermal reservoir, the second thermal reservoir is a low temperature reservoir, and the third thermal reservoir is a medium thermal reservoir.

In an eighth embodiment, in the pumped thermal energy storage system of the first embodiment, the sensed operational parameters include temperature, or pressure, or charge state for the plurality of thermal reservoirs, or some combination thereof.

In a ninth embodiment, in the pumped thermal energy storage system of the first embodiment, the recuperator has a low-pressure side and a high-pressure side. The working fluid circuit further includes: an expansion process fluidly coupled to the low-pressure side of the recuperator; and a compression process fluidly coupled the high-pressure side of the recuperator.

In a tenth embodiment, in the pumped thermal energy storage system of the ninth embodiment, the expansion process includes an expansion device and the compression process includes a compression device.

In an eleventh embodiment in the pumped thermal energy storage system of the ninth embodiment, the expansion device is a power-generating turbine and the compression device is a pump.

In a twelfth embodiment, in the pumped thermal energy storage system of the first embodiment, the flow control process includes: an electronic controller and a plurality of flow control valves. The flow control valves are positioned at a second set of predetermined points of the working fluid circuit and controlled by the electronic controller.

In a thirteenth embodiment, in the pumped thermal energy storage system of the twelfth embodiment, the flow control valves include variable orifice valves.

In a fourteenth embodiment, the first embodiment further comprises an auxiliary cooling system and the recuperator has a low-pressure side and a high-pressure side and the low-pressure side connected in parallel with the auxiliary cooling system. Balancing the heat transferred from the first thermal reservoir to the second thermal reservoir includes: dividing the working fluid on the low-pressure side into a first portion and a second portion, the first portion passing through the recuperator and the second portion passing through the auxiliary cooling system; and dividing the working fluid on the high-pressure side into a third portion and a fourth portion, the third portion passing through the recuperator and the fourth portion passing through the first thermal reservoir.

In a fifteenth embodiment, in the pumped thermal energy storage system of the fourteenth embodiment, balancing the heat transferred into the working fluid with the heat transferred out of the working fluid includes achieving a desired target ratio of Q_{HTR}/Q_{LTR} and Q_{MTR}/Q_{LTR} simultaneously and dynamically during system operation.

In a sixteenth embodiment, in the pumped thermal energy storage system of the first embodiment, balancing the heat transferred into the working fluid with the heat transferred out of the working fluid includes achieving a desired target ratio of Q_{HTR}/Q_{LTR} and Q_{MTR}/Q_{LTR} simultaneously and dynamically during system operation.

In a seventeenth embodiment, a pumped thermal energy storage system, in a generating phase comprises, a working fluid system, a sensor system, and a flow control process. The working fluid circuit includes: a working fluid circulating through the working fluid circuit, an expansion device, a compression device, a plurality of thermal reservoirs, and a recuperator. The plurality of thermal reservoirs includes a low temperature reservoir, a medium temperature reservoir, and a high temperature reservoir. The recuperator is fluidly coupled to the compression device on the high-pressure side and fluidly coupled to the expansion device on the low-pressure side. The sensor system senses operational parameters of the working fluid at a first set of predetermined points in the working fluid circuit. The flow control process includes a plurality of flow control valves, controls the flow of the working fluid through the working fluid circuit by operation of the flow control valves, and is responsive to the sensed operational parameters, controlling the flow of the working fluid to achieve a desired target ratio of Q_{HTR}/Q_{LTR} and Q_{MTR}/Q_{LTR} simultaneously and dynamically during system operation.

In an eighteenth embodiment, in the pumped thermal energy storage system of the seventeenth embodiment, the expansion device is a power turbine and the compression device is a pump.

In a nineteenth embodiment, in the pumped thermal energy storage system of the seventeenth embodiment, the sensed operational parameters include temperature, or pressure, a charge state for the plurality of thermal reservoirs, or some combination thereof.

In a twentieth embodiment, in the pumped thermal energy storage system of the seventeenth embodiment, the flow control process includes an electronic controller and a plurality of flow control valves positioned at a second set of predetermined points of the working fluid circuit and controlled by the electronic controller.

In a twenty-first embodiment, in the pumped thermal energy storage system of the twentieth embodiment, the flow control valves include variable orifice valves.

In a twenty-second embodiment, the pumped thermal energy storage system of the seventeenth embodiment further comprises an auxiliary cooling system. Controlling the flow of a working fluid through the working fluid circuit includes: dividing the working fluid on the low-pressure side into a first portion and a second portion, the first portion passing through the recuperator and the second portion passing through the auxiliary cooling system; and dividing the working fluid on the high-pressure side into a third portion and a fourth portion, the third portion passing through the recuperator and the fourth portion passing through the thermal reservoir.

In a twenty-third embodiment, a method for operating a pumped thermal energy storage system, comprises: cycling the pumped thermal energy storage system through a generating phase and a charging phase; circulating a working fluid through a working fluid circuit; sensing operational parameters of the working fluid at a first set of predetermined points in the working fluid circuit as the working fluid circulates; and in the generating phase, controlling the flow of a working fluid through the working fluid circuit responsive to the sensed operational parameters to balance the heat transferred from a first thermal reservoir with the heat transferred to a second thermal reservoir.

In a twenty-fourth embodiment, in the method of the twenty-third embodiment, circulating the working fluid through the working fluid circuit includes alternately expanding the working fluid and compressing the working fluid between heat exchanges.

In a twenty-fifth embodiment, in the method of the twenty-third embodiment, controlling the flow of the working fluid includes: recuperating heat from the circulating working fluid using a recuperator; dividing the working fluid on a low-pressure side of a recuperator into a first portion and a second portion, the first portion passing through the recuperator and the second portion passing through an auxiliary cooling system; and dividing the working fluid on a high-pressure side of the recuperator into a third portion and a fourth portion, the third portion passing through the recuperator and the fourth portion passing through a thermal reservoir.

In a twenty-sixth embodiment, in the method of the twenty-fifth embodiment, the first thermal reservoir is a high temperature thermal reservoir and the second thermal reservoir is a low temperature reservoir.

In a twenty-seventh embodiment, in the method of the twenty-fifth embodiment, the first thermal reservoir is a medium temperature thermal reservoir and the second thermal reservoir is a low temperature reservoir.

In a twenty-eighth embodiment, in the method of the twenty-third embodiment, the sensed operational parameters include temperature, or pressure, or charge state for the plurality of thermal reservoirs, or some combination thereof.

In a twenty-ninth embodiment, in the method of the twenty-sixth embodiment, controlling the flow of the working fluid includes achieving a desired target ratio of Q_{HTR}/Q_{LTR} and Q_{MTR}/Q_{LTR} simultaneously and dynamically during system operation.

In a thirtieth embodiment, in the method of the twenty-third embodiment, controlling the flow of the working fluid includes achieving a desired target ratio of Q_{HTR}/Q_{LTR} and Q_{MTR}/Q_{LTR} simultaneously and dynamically during system operation.

In a thirty-first embodiment, a computer-implemented method for controlling a pumped thermal energy storage system, comprising: receiving a plurality of sensor signals from a plurality of sensors sensing operational parameters of a working fluid at a first set of predetermined points in a working fluid circuit while the working fluid is circulating through a working fluid circuit in a generating phase; and in the generating phase, responsive to the received sensor signals, sending a plurality of control signals to a plurality of flow control valves positioned at a second set of predetermined points in the working fluid circuit to balance the heat transferred from a first thermal reservoir with the heat transferred to a second thermal reservoir.

In a thirty-second embodiment, in the computer-implemented method of the thirty-first embodiment, the first thermal reservoir is a high temperature thermal reservoir and the second thermal reservoir is a low temperature reservoir.

In a thirty-third embodiment, in the computer-implemented method of the thirty-first embodiment, the first thermal reservoir is a medium temperature thermal reservoir and the second thermal reservoir is a low temperature reservoir.

In a thirty-fourth embodiment, in the computer-implemented method of the thirty-first embodiment, the sensed operational parameters include temperature, or pressure, or charge state for the plurality of thermal reservoirs, or some combination thereof.

In a thirty-fifth embodiment, in the computer-implemented method of the thirty-first embodiment, balancing the heat transferred into the working fluid with the heat transferred out of the working fluid includes: recuperating heat from the circulating working fluid using a recuperator; dividing the working fluid on a low-pressure side of the recuperator into a first portion and a second portion, the first portion passing through the recuperator and the second portion passing through an auxiliary cooling system; and dividing the working fluid on a high-pressure side of the recuperator into a third portion and a fourth portion, the third portion passing through the recuperator and the fourth portion passing through a thermal reservoir.

In a thirty-sixth embodiment, in the computer-implemented method of the thirty-fifth embodiment, balancing the heat transferred into the working fluid with the heat transferred out of the working fluid includes achieving a desired target ratio of Q_{HTR}/Q_{LTR} and Q_{MTR}/Q_{LTR} simultaneously and dynamically during system operation.

In a thirty-seventh embodiment, in the computer-implemented method of the thirty-first embodiment, balancing the heat transferred into the working fluid with the heat transferred out of the working fluid includes achieving a desired target ratio of Q_{HTR}/Q_{LTR} and Q_{MTR}/Q_{LTR} simultaneously and dynamically during system operation.

In a thirty-eighth embodiment, an apparatus, comprises a flow process control that, in use, operates in a pumped thermal energy storage (“PTES”) system cycling through a generating phase and a charging phase. The flow process control includes an electronic controller. The electronic controller comprises a processor-based resource; and a memory. The memory is encoded with executable instructions that, when executed by the processor-based resource, perform a method. The method comprises: receiving a plurality of sensor signals from a plurality of sensors sensing operational parameters of a working fluid of the PTES system at a first set of predetermined points in a working fluid circuit while the working fluid is circulating through a working fluid circuit in a generating phase; and in the generating phase, responsive to the received sensor signals, sending a plurality of control signals to a plurality of flow control valves positioned at a second set of predetermined points in the working fluid circuit to balance the heat transferred from a first thermal reservoir with the heat transferred to a second thermal reservoir.

In a thirty-ninth embodiment, in the apparatus of the thirty-eighth embodiment, the flow process control further includes the plurality of flow control valves.

In a fortieth embodiment, the apparatus of the thirty-ninth embodiment further comprises further comprising a sensor system including the plurality of sensors.

In a forty-first embodiment, the apparatus of the thirty-seventh embodiment further comprises a pumped thermal energy storage system working fluid circuit. In the generating phase, the pumped thermal energy storage system includes: a working fluid circulating through the working fluid circuit; a recuperator; and a plurality of thermal reservoirs, the plurality of thermal reservoirs including at least the first thermal reservoir and the second thermal reservoir.

In a forty-second embodiment, the apparatus of the thirty-sixth embodiment further comprises a pumped thermal energy storage system working fluid circuit that, in the generating phase, includes: a working fluid circulating through the working fluid circuit; a recuperator; and a plurality of thermal reservoirs, the plurality of thermal reservoirs including at least the first thermal reservoir and the second thermal reservoir.

In a forty-third embodiment, the apparatus of the fortieth embodiment further comprises a sensor system including the plurality of sensors.

In a forty-fourth embodiment, the apparatus of the fortieth embodiment further comprises a pumped thermal energy storage system working fluid circuit that, in the generating phase, includes: a working fluid circulating through the working fluid circuit; a recuperator; and a plurality of thermal reservoirs, the plurality of thermal reservoirs including at least the first thermal reservoir and the second thermal reservoir.

In a forty-fifth embodiment, in the pumped thermal energy storage system of the first embodiment, the balancing of the heat transferred from the first thermal reservoir with the heat transferred to the second thermal reservoir includes attaining a ratio of heat transferred from the first thermal reservoir with the heat transferred to the second thermal reservoir≠1.

In a forty-sixth embodiment, in the pumped thermal energy storage system of the seventeenth embodiment, the desired target ratio of Q_{HTR}/Q_{LTR} and Q_{MTR}/Q_{LTR}≠1.

In a forty-seventh embodiment, in the method of the twenty-third embodiment, the balance of the heat transferred from the first thermal reservoir with the heat transferred to the second thermal reservoir includes attaining a ratio of heat transferred from the first thermal reservoir with the heat transferred to the second thermal reservoir≠1.

In a forty-eighth embodiment, in the computer-implemented method of the thirty-first embodiment, the balance of the heat transferred from the first thermal reservoir with the heat transferred to the second thermal reservoir includes attaining a ratio of heat transferred from the first thermal reservoir with the heat transferred to the second thermal reservoir≠1.

In a forty-ninth embodiment, in the apparatus of the thirty-eighth embodiment, the balance of the heat transferred from the first thermal reservoir with the heat transferred to the second thermal reservoir includes attaining a ratio of heat transferred from the first thermal reservoir with the heat transferred to the second thermal reservoir≠1.

In a fiftieth embodiment, the pumped thermal energy storage system of the first embodiment further comprises an auxiliary cooling system in parallel with a low pressure side of the recuperator.

In a fifty-first embodiment, the pumped thermal energy storage system of the seventeenth embodiment further comprises an auxiliary cooling system in parallel with a low pressure side of the recuperator.

This concludes the detailed description. The particular embodiments disclosed above are illustrative only, as the claimed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the claims. Accordingly, the protection sought herein is as set forth in the claims below.

1. A pumped thermal energy storage system, comprising:
in a generating phase:
a working fluid circuit including:
a working fluid circulating through the working fluid circuit;
a recuperator; and
a plurality of thermal reservoirs, the plurality of thermal reservoirs including at least a first thermal reservoir and a second thermal reservoir; and
a sensor system sensing operational parameters of the working fluid at a first set of predetermined points in the working fluid circuit and at least a portion of the plurality of thermal reservoirs; and
a flow control process:
controlling the flow of the working fluid through the working fluid circuit; and
responsive to the sensed operational parameters, balancing the heat transferred from the first thermal reservoir with the heat transferred to the second thermal reservoir.

2. The pumped thermal energy storage system of claim 1, wherein the first thermal reservoir is a high temperature thermal reservoir and the second thermal reservoir is a low temperature reservoir.

3. The pumped thermal energy storage system of claim 1, wherein the first thermal reservoir is a medium temperature thermal reservoir and the second thermal reservoir is a low temperature reservoir.

4. The pumped thermal energy storage system of claim 1, wherein:
the plurality of thermal reservoirs of the working fluid circuit includes a third thermal reservoir; and
the flow control process controls the flow of the working fluid through the working fluid circuit responsive to the sensed operational parameters to balance the heat transferred from at least one of the first reservoir and the third reservoir to the second reservoir.

5. The pumped thermal energy storage system of claim 4 wherein the first thermal reservoir is a high temperature thermal reservoir, the second thermal reservoir is a low temperature reservoir, and the third thermal reservoir is a medium thermal reservoir.

6. The pumped thermal energy storage system of claim 4, wherein the flow control process controls the flow of the working fluid through the working fluid circuit responsive to the sensed operational parameters to balance the heat transferred from both of the first reservoir and the third reservoir to the second reservoir.

7. The pumped thermal energy storage system of claim 6, wherein the first thermal reservoir is a high temperature thermal reservoir, the second thermal reservoir is a low temperature reservoir, and the third thermal reservoir is a medium thermal reservoir.

8. The pumped thermal energy storage system of claim 1, wherein the sensed operational parameters include temperature, or pressure, or charge state for the plurality of thermal reservoirs, or some combination thereof.

9. The pumped thermal energy storage system of claim 1, wherein:
the recuperator has a low-pressure side and a high-pressure side; and
the working fluid circuit further includes:
an expansion process fluidly coupled to the low-pressure side of the recuperator; and
a compression process fluidly coupled the high-pressure side of the recuperator.

10. The pumped thermal energy storage system of claim 9, wherein:
the expansion process includes an expansion device; and
the compression process includes a compression device.

11. The pumped thermal energy storage system of claim 9, wherein:
the expansion device is a power-generating turbine; and
the compression device is a pump.

12. The pumped thermal energy storage system of claim 1, wherein the flow control process includes:
an electronic controller; and
a plurality of flow control valves positioned at a second set of predetermined points of the working fluid circuit and controlled by the electronic controller.

13. The pumped thermal energy storage system of claim 12, wherein the flow control valves include variable orifice valves.

14. The pumped thermal energy storage system of claim 1, further comprising an auxiliary cooling system and wherein:
the recuperator has a low-pressure side and a high-pressure side, the low-pressure side connected in parallel with the auxiliary cooling system; and
balancing the heat transferred from the first thermal reservoir to the second thermal reservoir includes:
dividing the working fluid on the low-pressure side into a first portion and a second portion, the first portion passing through the recuperator and the second portion passing through the auxiliary cooling system; and
dividing the working fluid on the high-pressure side into a third portion and a fourth portion, the third portion passing through the recuperator and the fourth portion passing through the first thermal reservoir.

15. The pumped thermal energy storage system of claim 14, wherein balancing the heat transferred into the working fluid with the heat transferred out of the working fluid includes achieving a desired target ratio of Q_{HTR}/Q_{LTR} and Q_{MTR}/Q_{LTR} simultaneously and dynamically during system operation.

16. The pumped thermal energy storage system of claim 1, wherein balancing the heat transferred into the working fluid with the heat transferred out of the working fluid includes achieving a desired target ratio of Q_{HTR}/Q_{LTR} and Q_{MTR}/Q_{LTR} simultaneously and dynamically during system operation.

17. A pumped thermal energy storage system, comprising:
in a generating phase:
a working fluid circuit, including:
a working fluid circulating through the working fluid circuit;
an expansion device;
a compression device;
a plurality of thermal reservoirs, including:
a low temperature reservoir;
a medium temperature reservoir; and
a high temperature reservoir; and
a recuperator
fluidly coupled to the compression device on the high-pressure side and fluidly couple to the expansion device on the low-pressure side;
a sensor system sensing operational parameters of the working fluid at a first set of predetermined points in the working fluid circuit; and
a flow control process including a plurality of flow control valves, the flow control process:
controlling the flow of the working fluid through the working fluid circuit by operation of the flow control valves; and
responsive to the sensed operational parameters, controlling the flow of the working fluid to achieve a desired target ratio of Q_{HTR}/Q_{LTR} and Q_{MTR}/Q_{LTR} simultaneously and dynamically during system operation.

18. The pumped thermal energy storage system of claim 17, wherein:
the expansion device is a power turbine; and
the compression device is a pump.

19. The pumped thermal energy storage system of claim 17, wherein the sensed operational parameters include temperature, or pressure, a charge state for the plurality of thermal reservoirs, or some combination thereof.

20. The pumped thermal energy storage system of claim 17, wherein the flow control process includes:
an electronic controller; and
a plurality of flow control valves positioned at a second set of predetermined points of the working fluid circuit and controlled by the electronic controller.

21. The pumped thermal energy storage system of claim 20, wherein the flow control valves include variable orifice valves.

22. The pumped thermal energy storage system of claim 17, further comprising an auxiliary cooling system and wherein controlling the flow of a working fluid through the working fluid circuit includes:
dividing the working fluid on the low-pressure side into a first portion and a second portion, the first portion passing through the recuperator and the second portion passing through the auxiliary cooling system; and
dividing the working fluid on the high-pressure side into a third portion and a fourth portion, the third portion passing through the recuperator and the fourth portion passing through the thermal reservoir.

23. A method for operating a pumped thermal energy storage system, comprising:
cycling the pumped thermal energy storage system through a generating phase and a charging phase;
circulating a working fluid through a working fluid circuit;
sensing operational parameters of the working fluid at a first set of predetermined points in the working fluid circuit as the working fluid circulates; and
in the generating phase, controlling the flow of a working fluid through the working fluid circuit responsive to the sensed operational parameters to balance the heat transferred from a first thermal reservoir with the heat transferred to a second thermal reservoir.

24. The method of claim 23, wherein circulating the working fluid through the working fluid circuit includes alternately expanding the working fluid and compressing the working fluid between heat exchanges.

25. The method of claim 23, wherein controlling the flow of the working fluid includes:
recuperating heat from the circulating working fluid using a recuperator;
dividing the working fluid on a low-pressure side of a recuperator into a first portion and a second portion, the first portion passing through the recuperator and the second portion passing through an auxiliary cooling system; and
dividing the working fluid on a high-pressure side of the recuperator into a third portion and a fourth portion, the third portion passing through the recuperator and the fourth portion passing through a thermal reservoir.

26. The method of claim 25, wherein the first thermal reservoir is a high temperature thermal reservoir and the second thermal reservoir is a low temperature reservoir.

27. The method of claim 25, wherein the first thermal reservoir is a medium temperature thermal reservoir and the second thermal reservoir is a low temperature reservoir.

28. The method of claim 25, wherein the sensed operational parameters include temperature, or pressure, or charge state for the plurality of thermal reservoirs, or some combination thereof.

29. The method of claim 26, wherein controlling the flow of the working fluid includes achieving a desired target ratio of Q_{HTR}/Q_{LTR} and Q_{MTR}/Q_{LTR} simultaneously and dynamically during system operation.

30. The method of claim 23, wherein controlling the flow of the working fluid includes achieving a desired target ratio of Q_{HTR}/Q_{LTR} and Q_{MTR}/Q_{LTR} Simultaneously and dynamically during system operation.

31-44. (canceled)

45. The pumped thermal energy storage system of claim 1, wherein the balancing the heat transferred from the first thermal reservoir with the heat transferred to the second thermal reservoir includes attaining a ratio of heat transferred from the first thermal reservoir with the heat transferred to the second thermal reservoir≠1.

46. The pumped thermal energy storage system of claim 17, wherein the desired target ratio of Q_{HTR}/Q_{LTR} and Q_{MTR}/Q_{LTR}≠1.

47. The method of claim 23, wherein the balance of the heat transferred from the first thermal reservoir with the heat transferred to the second thermal reservoir includes attaining a ratio of heat transferred from the first thermal reservoir with the heat transferred to the second thermal reservoir≠1.

48-49. (canceled)

50. The pumped thermal energy storage system of claim 1, further comprising an auxiliary cooling system in parallel with a low pressure side of the recuperator.

51. The pumped thermal energy storage system of claim 17, further comprising an auxiliary cooling system in parallel with a low pressure side of the recuperator.
